(19) United States
(12) Patent Application Publication
(10) Pub. No.: US 2009/0236027 A1
(43) Pub. Date: Sep. 24, 2009

(54) Blood Treatment Filter and Method of Manufacturing

(75) Inventors: Martin STILLIG, Dransfeld (DE); Jeffrey H. Burbank, Boxford, MA (US); Goetz Friederichs, Boston, MA (US); James M. Brugger, Newburyport, MA (US)

Correspondence Address: MILES & STOCKBRIDGE PC, 1751 PINNACLE DRIVE, SUITE 500, MCLEAN, VA, 22102-3833, US

(73) Assignee: NxSTAGE MEDICAL, INC.

(21) Appl. No.: 12/478,920

(22) Filed: Jun. 5, 2009

Related U.S. Application Data
(62) Division of application No. 11/553,148, filed on Oct. 26, 2006.
(60) Provisional application No. 60/596,888, filed on Oct. 27, 2005.

(51) Int. Cl. B01D 67/00

(52) U.S. Cl. 156/69; 156/294

(57) ABSTRACT

A configuration of a blood microtubular filter/dializer used in many kinds of renal replacement therapy systems is disclosed which may allow a straight thin-walled tube to be used for a majority of the structure of the housing and other benefits disclosed.

### PRIORITY DATA AND INCORPORATION BY REFERENCE

This application claims benefit of priority to U.S. Provisional Patent Application No. 60/593,888, filed Oct. 27, 2005 which is incorporated by reference in its entirety.

### BACKGROUND

One of the more expensive components of blood treatment systems, such as renal replacement therapy systems, are the filter devices used for blood purification and fluid sterilization. A common structure for such devices includes a molded housing that holds tubular membranes that open at opposite ends of the media in inlet and outlet headers. The cost of manufacture involves considerable capital expense for the molds used to create the housing. This first cost discourages providing multiple filter designs for the various applications of these filter devices. Also, there is a need for filter designs that require less material, are more robust, and which are amenable to consistent high quality manufacturing.

The inventive embodiments provide various other features and advantages in addition to or in lieu of those discussed above and below. Many of these features and advantages are apparent from the description below with reference to the following drawing.

### BRIEF DESCRIPTION OF THE DRAWINGS

FIG. 1 is a cross-section view of a filter usable in a variety of different types of blood treatment systems oriented to trap air in one or two header portions of the filter.

FIGS. 2A through 2C illustrate holders for use with the filter device embodiment described herein, including a particular example of application to a blood treatment device such as that of FIG. 1.

FIG. 2D illustrates an example of a holder feature to restrict orientations of a filter ensure that the filter is oriented with respect to the force of gravity.

FIG. 3 illustrates a filter similar to that of FIG. 1 but with a header port for removing air and/or disrupting or cleaning clots.

FIG. 4A illustrates an assembly for use with the port of FIG. 3 for removing air and/or disrupting or cleaning clots.

FIG. 4B illustrates a drip-chamber (or bubble trap) embodiment similar to the embodiment of FIG. 4A.

FIG. 5 illustrates a header cap with a hydrophobic membrane for automatically venting air.

FIGS. 6A through 9B illustrate a method for manufacturing a filter having a two-piece header caps that allow the use of a cylinder for a majority of the filter.

FIGS. 10A, 10B, and 11 illustrate the filter whose manufacture is described with respect to FIGS. 6A through 9B.

FIG. 12 shows an alternative configuration for connecting a dialysate manifold with a tubular body of the a filter according to an embodiment of the invention.

FIG. 13 illustrates a single element header component that uses a simple tube for the dialysate portion.

### DETAILED DESCRIPTION OF THE DRAWINGS

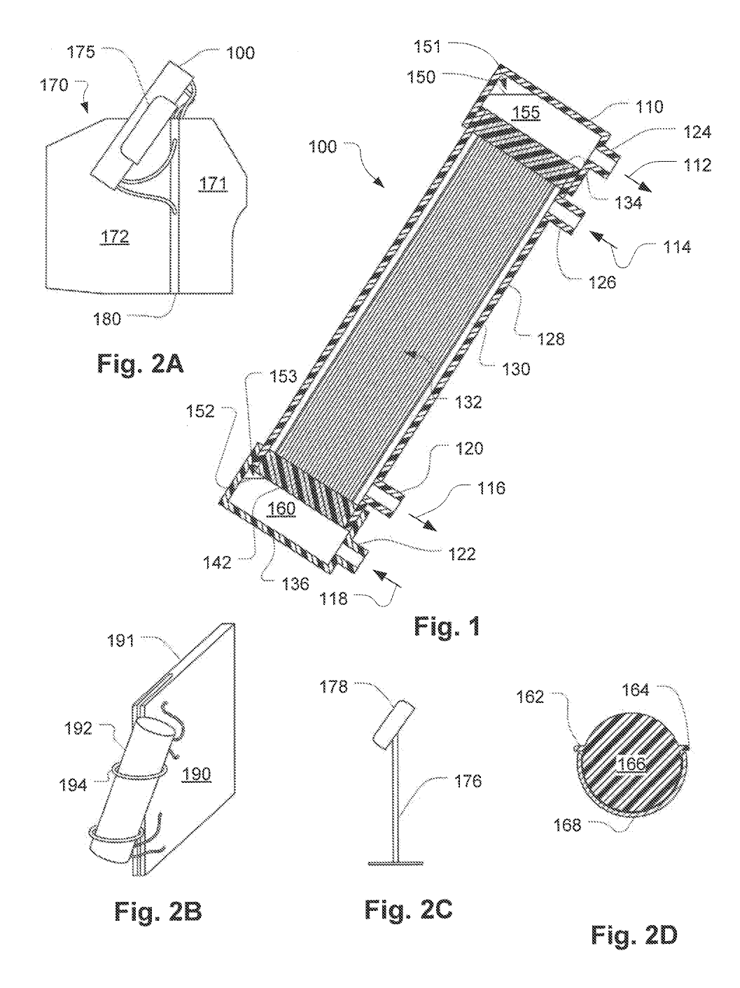

FIG. 1 is a cross-section view of a filter usable in a variety of different types of blood treatment systems oriented to trap air in one or two header portions of the filter. A filter 100, which may be a dialyzer, hemofilter, hemodiafilter, or any other compatible blood treatment has a bundle of tubular media 132 connecting an arterial 160 and venous 155 head space which is isolated from a filtrate space 130. Blood flows through ports 122 and 124 in header caps 110 and 136 as indicated by arrows 118 and 112 into and out of the arterial 160 and venous 155 head spaces, respectively. A cylindrical filter body 128 encloses the filtrate space 130 and contains filtrate (e.g., dialyzer) ports 126 and 120. Arterial and venous headers 142 and 134 isolate the filtrate space 130 from the respective arterial 160 and venous 155 head spaces.

The orientation of the filter 100 with respect to the pull of gravity is shown with the understanding that gravity is assumed to pull down with respect to the profile orientation of the drawing page. If any air is entrained in the blood, it may settle in pockets 151 and 153 in the arterial 160 and venous 155 head spaces as indicated by air/liquid interfaces 152 and 150. The flow of blood through the arterial 160 and venous 155 head spaces is extremely slow due to the very small cross-sectional areas of the filter fibers in the bundle 132. As a result, the arterial 160 and venous 155 head spaces are an idea place for air to settle out. With the indicated orientation, with blood outlet 124 pointing down and away from the pocket 151. Since the blood moves at a very slow rate in the arterial 160 and venous 155 head spaces, there is little risk of reentrainment and air settles out very effectively.

Air trapped in pocket 153 may travel through filter fibers in bundle 132 up to venous head space 155 and accumulate in pocket 151. Since the pocket 153 is located near the top of the arterial head space 160, air will tend to travel up a few of the fibers closest to the top and collect in the pocket 151 without mixing in with blood. This keeps the vast majority of fibers filled with blood.

FIGS. 2A through 2C illustrate holder variations for the filter embodiments of the present patent disclosure. The variations are intended to illustrate examples and not intended to be comprehensive or limiting. In FIG. 2A, a holder 175 of a blood treatment machine orients a filter such as that of FIG. 1 and those of the further filter embodiments described below. The holder 175 may be attached at a base thereof (not shown separately) to a blood treatment machine 172 which may contain actuators, sensors, and control elements as well as a fluid circuit, here illustrated as a cartridge 180 enclosed between two parts 171 and 172 of the blood treatment machine 172. A filter 100 that is preconnected to the fluid circuit can easily be mounted in such an apparatus. The holder 175 may be articulating to allow for some movement or change of orientation of the filter 100 and is preferably a spring-tensioned clamp that allows for one-handed insertion of a filter 100. In an alternative embodiment, the holder 175 may be attached to the 180 cartridge such that its orientation is obtained when the cartridge 180 is positioned with respect to the blood treatment machine 170. In FIG. 2B, a holder 194 is integrated into a disposable unit 190 (such as the fluid circuit cartridge of FIG. 2A). For example, the holder 194 may be made of wire which is connected to a plastic panel support 191 of the disposable unit. Examples of such disposable units are disclosed in U.S. Pat. No. 6,955,655 for “Hemofiltration system” and U.S. Pat. No. 6,579,253 for “Fluid processing systems and methods using extracorporeal fluid flow panels oriented within a cartridge,” each of which is hereby incorporated by reference as if full set forth in its entirety herein and U.S. patent application Ser. No. 10/650,935 published as US 2004-0069709, which is incorporated by reference above. The holder 194 supports a filter 192 such that when the disposable unit 190 is mounted, in a treatment device such as 170, the filter 192 is held at an angle as shown.

Another alternative arrangement shown in FIG. 2C is to provide a separate support 178 that is attached, or attachable, to a support 176.

FIG. 2D illustrates an example of a holder feature to restrict orientations of a filter ensure that the filter is oriented with respect to the force of gravity. The view is a sectional view. In the example, the filter 166 has tabs 162 and 164 that prevent the filter 166 from being received fully within a flexible trough 168 which functions as a holder. This may be confirmed by inspection. The flexible trough 168 allows the filter 166 body to fit into it fully in only one orientation, the holder providing an urging force that keeps the filter 166 in place when inserted. Note that the example illustrated in FIG. 2D is only one of many devices that may be used to restrict the orientation of the filter when attached to a holder and is not intended to be limiting of the scope of any of the inventions described in the present disclosure.

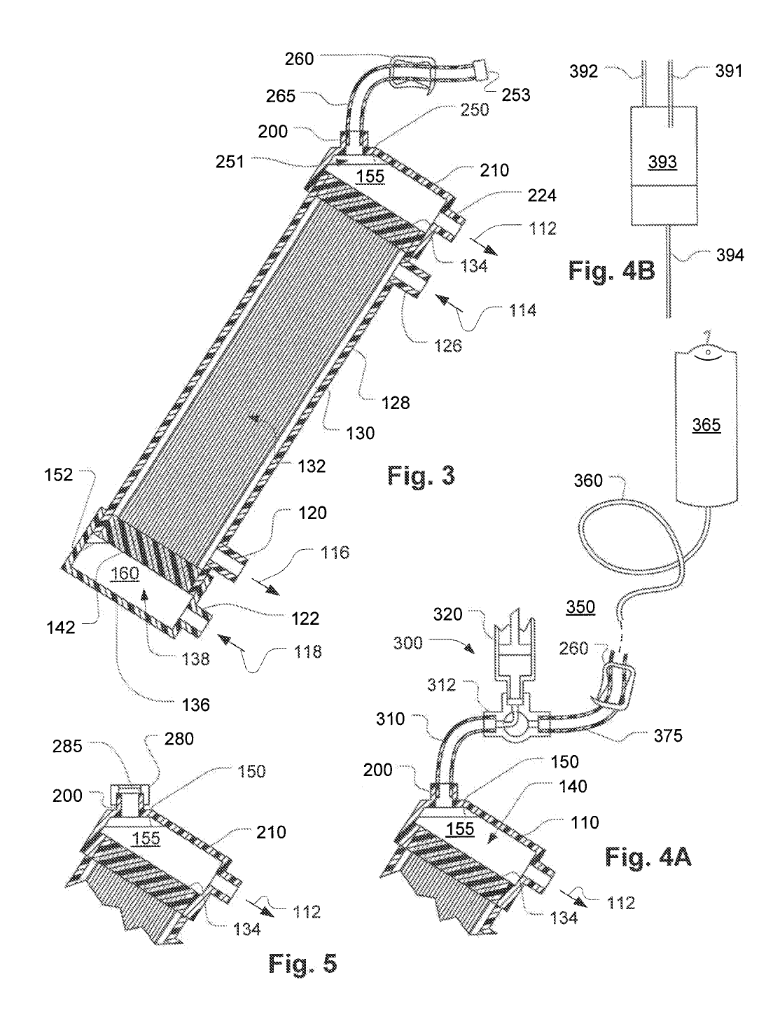

FIG. 3 illustrates a filter similar to that of FIG. 1 but with a header cap 210 having an integrated header port 200 for removing air and/or disrupting or cleaning clots. Tubing 265 may be connected to the port and provided with a clamp 260. The clamp 260 may be released, at intervals, by an operator, to vent air from the air pocket 251 and re-engaged to prevent blood loss. The clamp 260 may be a normally-closed type clamp with a strong spring so that it reclamps tubing 265 when released. The tubing 265 may be capped with a microporous filter end cap 253 to prevent any contamination re-entering the blood in the venous head space 155. The entire assembly that includes the filter 100, tubing 265, and microporous filter end cap 253 may be fused, sealed, and sterilized as a unit. In addition the same may be fused, sealed and sterilized as a unit with an entire treatment circuit, combining it with the circuit described in U.S. patent application Ser. No. 10/650,935 published as US 2004-0069709, which is hereby incorporated by reference as if full set forth in its entirety herein. With this combination, the entire circuit may be isolated from contamination.

FIG. 4A illustrates an assembly 350 for use with the port of FIG. 3 for removing air and/or disrupting or cleaning clots. The port 200 has a tube 310 connecting the venous head space 155 with a multi-way valve (e.g., a stopcock as shown) 312. The multi-way valve 312 is further connected to a syringe 320 and tubing 375 connecting a supply of blood normal saline 375, heparin, drug, or other medicament (such as from a tube 360 and bag 365) such as anticoagulants, drugs, etc. The multi-way valve allows the syringe to be connected, in a first position, to draw saline from the source of saline 375 and, in a second position, to draw air from the venous head space 155. In the second position, saline may be pushed into the head space 155 to clear clots or for prophylaxis by injecting medicament, for example, an anticoagulant such as heparin. In an illustrative usage method, the multi-way valve 312 is set in the second position and air is drawn from the head space 155. Then it is set in the first position and saline is drawn into the syringe 320. Then the multi-way valve 312 is set in the second position again and saline (or saline and heparin) is injected into the venous head space 155. The apparatus including the multi-way valve 312, syringe 320, tubing 310, 375, 360 and clamp 260 may be pre-attached to the filter 100 and presterilized as a unit.

Note that besides using the multi-way valve and bag 365 to draw air from the header of a filter and inject medicaments into the filter header, the same devices may be used in connection with an air trap or drip chamber. Referring to FIG. 4B, a drip chamber 393 (which could also be a bubble trap or other similar device in which air may accumulate and possibly be vented), has an inlet 391 and an outlet 394. A connection 392 to the top of the drip chamber 393 may be connected to the line 310 shown in FIG. 4A and used in the manner described for removing air and/or injecting medicaments.

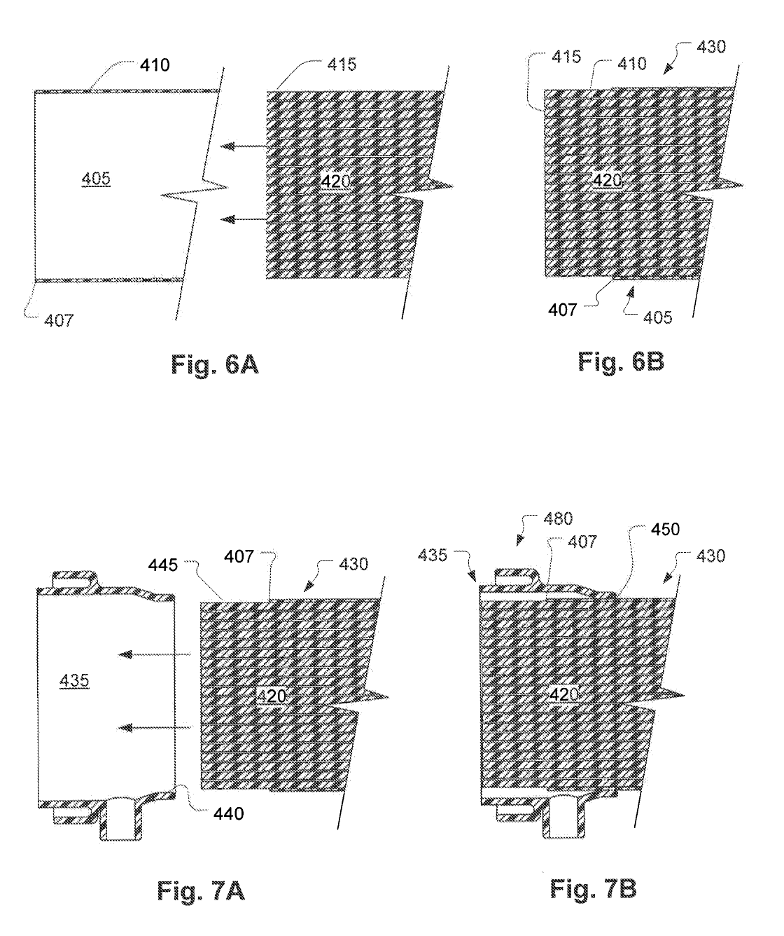

FIG. 5 illustrates a header cap 210 with cover 280 sealed to and covering the header port 200. The cover includes a hydrophobic membrane 285 that allows air in the head space 155 to vent automatically while preventing any contamination from entering. Referring to FIGS. 6A and 6B, a method for manufacturing a filter design that incorporates features of the foregoing examples begins with the insertion of a filter fiber bundle 420 into a cylindrical tube 405 which forms part of a housing (discussed with reference to FIG. 11). The tube 405 is a straight tube with no other structural features, in the present example. As such, the tube 405 may be a thin walled structure allowing material to be saved. In addition, it may be made of a material that is not necessarily injection moldable, as filter housings generally are. A preferred material is glycol-modified polyethylene terephthalate, a copolyester (PETG) which may be a clear amorphous thermoplastic with high stiffness, hardness, and toughness as well as good impact strength. Other advantages of using a tube for the main part of the housing will become clear from the further description below. Note that in the drawing only one end of the tube is shown in the present and following figures, but a complementary operation may be performed at an opposite end of the tube 405 such that a mirror-image structure is obtained.

The filter fiber membrane bundle 420 may be inserted such that the fibers 415 extend beyond the end 407 of the tube 405 as indicated at 445. Referring now to FIGS. 7A and 7B, the resulting combination 430 of tube 405 and filter fibers 420 may be inserted in a dialysis cap 435. Note that the term “dialysis cap” is for convenience is not intended to limit the scope of the invention to the manufacture of a dialyzer. The outer surface of the tube 405 lies adjacent an inner annular surface 440 of the dialysis cap and a 450 bond is formed by thermal welding or sealing using adhesive, solvent, or filling type bonding agent such as urethane to form a completed structure 480. A symmetrical structure is formed at the opposite end so that both ends of the tube 405 have a dialysate cap 435.

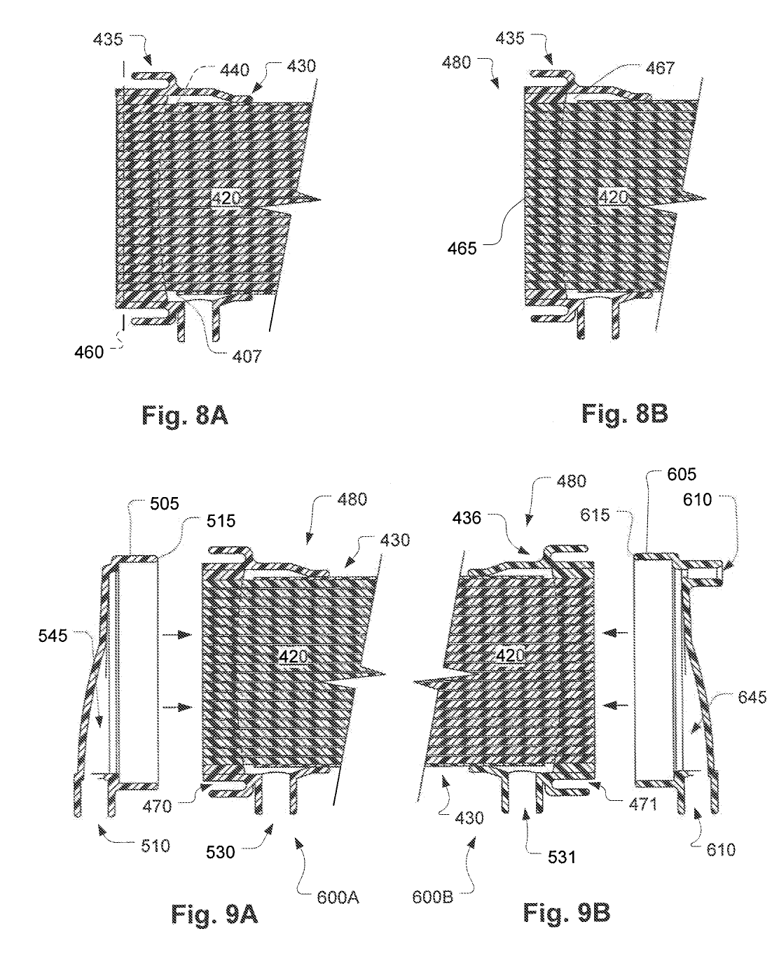

Referring now to FIGS. 8A and 8B, potting caps (not shown) are placed over the ends of the structure 480 and the ends of the fiber bundle are potted as according methods that are known in the art of manufacturing filters. A preferred method of potting is described in U.S. Pat. No. 6,872,346 for a “Method and apparatus for manufacturing filters,” which is hereby incorporated by reference as if fully set forth in its entirety herein. The result of potting is the creation of a sealed end of potting material indicated at 440 which, after hardening, is cut along a planar surface indicated at 460. The cut 460 is done in such a way that the end of the filter fibers 420 are open at the surface 465 forming. A portion of the dialysate cap 435 may be trimmed off in the process of cutting 460, as illustrated, although it will be apparent to those skilled in the art that this is not essential and instead, the fibers 420 could extend beyond the end of the dialysate cap 435 before potting such that the fibers 420 can be opened by cutting without cutting the dialysis cap

435. The completed end portion is shown in FIG. 8B, and as discussed, a symmetrical end portion may be completed at the opposite end (not shown here).

Referring now to FIGS. 9A through 11, the two ends 600A and 600B of a single tube structure are indicated. Respective blood caps 505 and 605 are fitted to the ends 600A and 600B of the structure 480. Each blood cap has a respective blood port 510, 610 and one of the blood caps has a secondary port 610 which will be recognized from the discussion of embodiments such as shown and discussed with respect to FIGS. 3 through 5. The blood caps 505 and 605 have respective header spaces 645 that are preferably hydraulically shaped to ensure that no, or a minimal number of, dead (stagnant flow of blood) spaces arise when in use. In the embodiment shown, a rim 515 fits into an annular recess 470 (or rim 615 into annular recess 471). Prior to fitting the blood caps 505 and 605, a bead 605, 606, 607, 608 of adhesive or sealing material may be applied or injected in the annular recesses 470 and 471 to form a bond between the structure 480 and the respective blood caps 505 and 605. The bonding may be done by thermal, friction, solvent welding, compression bonding, or other technique. Dialysate ports 30 and 531 in the dialysate caps 435 and 425, respectively, allow dialysate to flow into and out of the space occupied by bundle 420 and in contact with the external surfaces of the filter bundle 420. For a hemofilter or other kinds of filters, such as sterile filters, reverse osmosis filters, ultrafilters, etc.; only one “dialysate” port would be required. Blood ports 510 and 610 in blood caps 505 and 605, respectively, supply blood into, and be recovered from, the header spaces 545 and 645, respectively. Air can be removed from air removal/access port 610. As explained above, removal/access port 610 can also be used for injection of anticoagulants, drugs, or other medicaments.

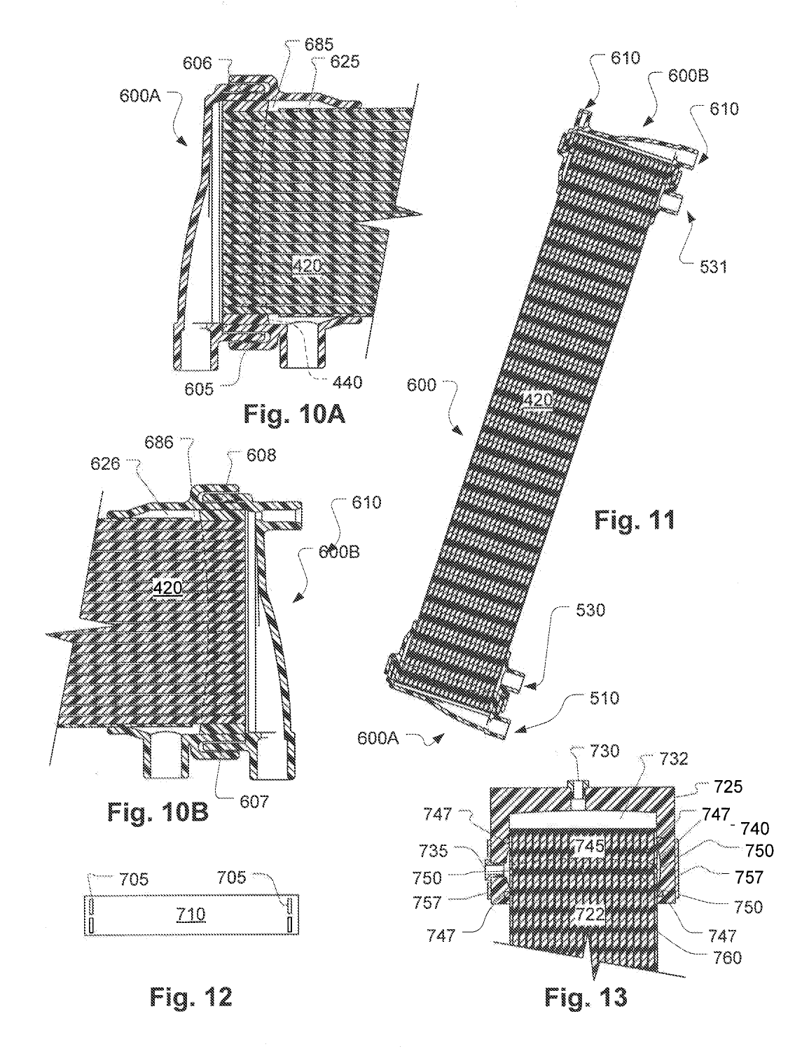

As best seen in FIGS. 10A and 10B, a small gap 685, 686 is provided between the end 407 (FIGS. 6A, 7A, 8A) of the tube 405 (FIGS. 6A, 6B) and the surface of the potting 440 to allow dialysate to flow into the space occupied by the filter bundle 420. The dialysate (or filtrate, depending on the application) is distributed by an annular dialysate manifold space 626, 626. Referring momentarily to FIG. 12, it is noted that instead of providing for the gap 685, 686 in the manner described, the fiber bundle may be extended all the way to the end 407 of the tube 405 and openings 705 can be provided to perform the function of the openings 685, 686. The same features provide for extraction of filtrate or dialysate or other fluid depending on the application. FIG. 11 shows a complete filter unit. One of the benefits of the design is that it makes it possible to confine the capital expense associated with injection molding to the dialysate and blood header reducing first costs in new filter designs. In addition, the design allows the tubular portion to be lengthened and shorted without requiring major design and manufacturing changes. Note that although injection molding is not contemplated to be a requirement for the practice of the invention or all its embodiments, it is a preferred means for achieving the high precision and economies of scale for articles of manufacture such as dialyzers, filters, and hemofilters, as well as other applications of the disclosed embodiments. Referring to FIG. 13, the benefit of using a tube for the filtrate/dialysate portion of the filter can be obtained by using a single element header cap rather than separate “dialysate” and “blood” caps. In the example shown, a one-piece cap 725 has an annular dialysate manifold 740 that is sealed by 0-rings 747 against the surface of a tube 760. A blood header space 732 is in communication with a blood port 730 and the dialysate manifold 740 is in communication with a dialysate port 735. Slits 750 (configured such as illustrated in FIG. 11) allow fluid communication between the dialysate manifold 740 and the external surfaces of the fiber bundle 733. A potting plug 745, in addition to performing its normal function, serves to reinforce the cylindrical structure of the tube 760 against the pressure of the 0-ring 747 seals. In this embodiment, a tube is permitted to be used with a single-element cap 725 structure providing many of the benefits of the inventions discussed above.

A tension band 757 may be used to ensure a good seal and provide a final shape to the one-piece cap 725 if made of a somewhat compliant resin to allow it to be removed from an injection mold despite the recess defined by the dialysate manifold 740. Alternatively, the one-piece cap 725 may have a discontinuous dialysate manifold that allows it to be created without requiring the cap to yield, the cap could be machined rather than molded, or the cap could be made of two molded pieces that are assembled into a single cap. Many variations are possible.

It will be understood that while the invention has been described above in conjunction with a few exemplary embodiments, the description and examples are intended to illustrate and not limit the scope of the invention. That which is described herein with respect to the exemplary embodiments can be applied to the measurement of many different formation characteristics. Thus, the scope of the invention should only be limited by the following claims.

1-2. (canceled)

3. A method of making a blood purification device, comprising the steps of:
sealingly affixing a generally annular first cap, which has a port and top and bottom axial ends that are open, to a straight tube inserted within said first cap so that an axial end of said tube terminates between said top and bottom axial ends;
providing a bundle of microtubular filter membranes inserted within said tube;
potting the ends of said filter membranes to form a header by spinning said tube and said first cap as a unit and cutting solidified potting material off the end such that said first cap port is in fluid communication with a manifold volume defined between a surface coinciding with an outside of said tube and an inner surface of said first cap, said manifold volume and said port being in fluid communication with external surfaces of said filter membranes and the interior of said tube, but fluidly isolated from interior surfaces of said filter membranes;
sealingly affixing a second cap, having a port, to said first cap such that said second cap defines a volume in fluid communication with said header and fluidly isolated from said tube interior.

4. A method as in claim 3, wherein said cutting includes cutting a portion of said first cap.

5. A method of making a blood purification device, comprising the steps of:
inserting a straight tube in a cylindrical end piece that has a portion toward a middle of the tube that fits snugly around the tube and a portion that has inner surface that is radially larger than the outer surface of the tube;
the cylindrical end piece having a port in fluid communication with a first manifold volume bounded by said inner surface;
said end piece extending beyond the end of when the tube is inserted in said inserting;
putting filter media fibers inside the tube either before or after said of inserting;
potting said fibers at their ends so that potting material forms a header bounded by the inner surface;
said step of potting being effective to fluidly isolate said first manifold volume from said header;
using an end cap with a port, capping the header to isolate a second manifold volume in fluid communication with said end cap port; said step of potting leaving a gap between and end of said tube such that an interior of said tube is open to said first manifold volume.

6. A method of making a blood purification device, comprising:
providing a straight tube having a desired length;
arranging a bundle of fibers in the tube;
coupling each end of the tube to a respective first end piece having a first port;
creating, for each tube end, a seal to fluidly isolate the insides of the fibers from the outsides of the fibers and the first port of the first end piece while leaving an interior of the straight tube in fluid communication with the first port such that fluid conveyed through the first port can contact the outsides of the fibers; and
coupling each respective first end piece to a second end piece having a second port to define a head space in communication with the second port and with the lumens of the fibers.

7. A method as in claim 6, wherein the straight tube is a simple cylinder with a featureless uninterrupted uniform circular cross-section over its entire length.

8. A method as in claim 6, further comprising cutting the straight tube from a continuous length of tube and wherein the first and second end pieces are injection molded.

9. A method as in claim 6, wherein the straight tube is of a material that is different from that of either the first end pieces or the second end pieces.

10. A method as in claim 6, wherein said creating a seal includes potting each end of the fiber bundle to form a header.

11. A method as in claim 6, wherein said creating a seal includes potting each end of the fiber bundle to form a header and the first end pieces at respective ends of the tube are configured to mate and thereby form the head space, in conjunction with said header.

12. A method as in claim 6, wherein the coupling includes moving an annular flange of the second end piece into an annular channel of the first piece in the direction of the axis of the straight tube.

13. A method of making a blood purification device, comprising:
attaching end members to opposite ends of a straight cylindrical tube to form a first flow channel connecting first ports of the annular end members by an inner volume of the tube enclosing filter fibers arranged such that the fiber bundle occupies substantially the entire inner volume of the tube, with length-wise ends of the fiber bundle extending past respective open ends of the straight cylindrical tube, each of the annular end members having a respective one of the first ports and being sealingly affixed to opposite end portions of the straight cylindrical tube, and the first flow channel being open to the outside at the ends of the straight cylindrical tube; and
forming, at each end of the straight cylindrical tube, a head space bound by a header that seals the open ends of the straight cylindrical tube and end cap, which has a second port to form a second flow channel, the second flow channel connecting the second ports of the end caps through the head spaces and lumens of the fiber bundle.

14. A method as in claim 13,
wherein said attaching includes sealingly affixing the annular end members to opposite end portions of the tube, the method further comprising arranging the fiber bundle in the inner volume of the tube, and
wherein the forming includes potting each end of the fiber bundle to form seals that define the headers.

15. A method as in claim 13, wherein the first and second flow channels are fluidly isolated from each other by seals of potting material at each end of the fiber bundle.

16. A method as in claim 13, wherein the straight cylindrical tube a simple cylinder with a featureless uninterrupted uniform circular cross-section over its entire length.

17. A method as in claim 13, further comprising cutting the straight cylindrical tube from a larger tube and injection molding the end members and end caps.

18. A method as in claim 13, wherein the straight cylindrical tube is of a material different from a material of either the annular end members or the end caps.

19. A method of making a blood purification device, comprising:
(a) sealing a respective first end of an annular channel to each opposite end of a straight tube of selectable length, the channel having at least one first port;
(b) sealing ends of microtubular filter fibers placed in the tube such that the lumens of the microtubular filter fibers are open to the outside and sealed off from the interior of the tube; the sealing being such that the interior of the tube is fully enclosed and accessible from the outside of the tube by the first ports;
(c) sealing a separate cap to each annular channel, each cap having at least one second port; the operation (c) being effective to completely seal the lumens of the microtubular fibers from the outside except for the second ports,
wherein the operations (a), (b), and (c) fluidly connect first ports through the straight tube and fluidly connect second ports through the lumens.

20. A method of making a blood purification device, comprising:
providing a straight tube; and
forming a structure within, and on, the straight tube that connects first ports at opposite ends of the tube by the lumens of filter fibers and connects second ports at opposite ends of the tube by the interior of the straight tube, such that the filter fiber lumens and the interior of the straight tube are fluidly isolated from each other;
the straight tube being a simple cylinder with a featureless uninterrupted uniform circular cross-section over its entire length, the forming being such that the straight tube can be of arbitrary length, including a length selected at a time of the forming.

21. A method as in claim 20, wherein the forming includes enclosing each end of the straight tube with first and second end members, the first end member carrying the second ports and the second end member carrying the first ports.

22. A method as in claim 21, wherein each first end member forms an annular ring shaped channel that communicates with the straight tube interior and a respective second port.

23. A method as in claim 22, wherein each second end member forms an enclosed head space bounded by a header into which said filter fibers open, the head space connecting the filter fibers lumens with the first port.

24. A method of making a blood purification device, comprising:
providing a straight tube configured as a cylinder with a featureless uninterrupted uniform circular cross-section over its entire length;
inserting a bundle of fibers in the straight tube;
coupling an end of the straight tube to a first end piece having a first port;
creating a seal to fluidly isolate the insides of the fibers from the outsides of the fibers and the first port of the first end piece, the outsides of the fibers being in communication with the first port; and
coupling the first end piece to a second end piece having a second port to define a head space in communication with the second port and the insides of the fibers.
